(19) United States
(12) Patent Application Publication
(10) Pub. No.: US 2003/0235297 A1
(43) Pub. Date: Dec. 25, 2003

(54) Mobile phone with detachable covers

(76) Inventors: Yung-Fa Cheng, Taipei (TW); Kuo-Hsiang Wu, Taipei (TW); Hsiang-Lung Kuo, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/272,334

(22) Filed: Oct. 16, 2002

(30) Foreign Application Priority Data
Jun. 21, 2002 (TW) 91209367

(51) Int. Cl. H04M 1/00

(52) U.S. Cl. 379/441

(57) ABSTRACT

A mobile phone with detachable covers. The phone body has a first engaging portion and a second engaging portion, and a cover, detachably connected to the body, including a third engaging portion and a fourth engaging portion. The body and the cover are separable. The third engaging portion is fastened to the first engaging portion, and the fourth connection is fastened to the second engaging portion.

### BACKGROUND OF THE INVENTION

1. Field of the Invention

The present invention relates in general to a mobile phone with detachable covers. In particular, the present invention relates to a mobile phone including a cover removably secured thereto such that the cover is easily detachable and interchangeable with other covers to satisfy the demands of variety. Moreover, the present invention relates to a mobile phone including a body and a cover, fastened by a lock with easy detachability for easy engagement.

2. Description of the Prior Art

Currently, mobile phone technology improves rapidly and the popularity thereof is expanding, such that mobile phone use is widespread. Models and colors are many and varied. Mobile phone design addresses not only communication service, user-friendly interface, light weight, and low power consumption, but also diverse interchangeable covers to change the appearance of the mobile phone.

In the present market, there are various types of mobile phones with detachable covers, for example, FIG. 1A shows a conventional mobile phone with a detachable cover, including a frame (13), a main circuit board (12), an upper cover (11) and a lower cover (14). The frame (13) is mainly made of metal or plastic to connect the printed circuit board (PCB) (12) with the upper and lower covers (11, 14) or a battery (not shown in the figure) . The upper and lower covers (11, 14) are usually made of plastic. The component demanded for changes in design is usually the upper cover (11). A plurality of hooks (110) is disposed on the interior side of the upper cover (11). On the frame (13), there is a first groove (130) corresponding to a first hook (110) of the upper cover (11). Furthermore, a plurality of elastic members (132) is disposed on the frame (13). When a user wants to assemble the cover and the body, the first hook (11) on the upper cover (11) must be aligned with the first groove (130) on the frame (13). Then, by applying external force, the first hook (110) and the first groove (130) are engaged. Finally, the first hook (110) is secured on the side of the first groove (130). By applying external force on the elastic member (132) disposed on the frame (13), the force bends the elastic member (132) and firmly connected to the lower cover (14) to complete assembly of the mobile phone. Also, when separating the covers from each other, applying external force on the elastic member (132) separates it from the lower cover. Then, the first hook (110) on the upper cover (11) and the first groove (130) on the frame (13) are separated to remove the covers from the mobile phone. FIG. 1B shows the local enlarged view of the first hook (110) disposed on the cover (11). The first hook (110) is made of plastic, so when external force is applied thereon, the force bends the first hook (110) elastically, and consequently, the first hook (11) slips into the first groove (130) to connect the upper cover (11) with the frame (13). Since the first hook (110) is manufactured with a predetermined slope, the first hook (110) can be easily removed from the frame when separating the covers.

The method mentioned above is most widely seen on mobile phones with interchangeable covers. However, plastic is a common material for the covers, which frequently cracks. Moreover, as shown in the above figure, it is necessary to carefully target the hook on the groove to engage them and the structures thereof are tiny, so it is difficult and also time-consuming to engage them. As well, even if the connection is not broken due to excessive external force, the elastic member may become fatigued due to changing of covers (frequent connection and separation), and thus, the hook or groove may ultimately fragment. In some cases, if the mobile phone is dropped or jarred, the design of the hook and groove will not sustain the reaction force and the components may fall apart or fracture. Thus, the covers cannot protect the PCB, the screen, and other components. Furthermore, the covers are made of plastic, and to withstand repeated use, must be manufactured with required thickness. Thus, the covers of the mobile phone cannot be thin and light.

Based on the above, the shortcomings of conventional mobile phones are as follows: difficult engagement between the hook and the groove, low strength of hook and groove, and inconveniently thick covers.

### SUMMARY OF THE INVENTION

An object of the present invention is to provide a mobile phone with detachable covers without hook-groove structures and the elastic member. The thickness of the mobile phone covers is greatly reduced and also provides optimum strength to protect the body. Changing covers is easy and fast.

Another object of the present invention is to provide a mobile phone with detachable covers, including a body with a first engaging portion and a second engaging portion thereon, and a cover detachably connected to the body with a third engaging portion and a fourth engaging portion thereon. When engaging the body and the cover together, the third engaging portion is fastened to the first connection, and then the fourth engaging portion is fastened to the second engaging portion so that the cover and the body are firmly connected.

Moreover, another object of the present invention is to provide a mobile phone with detachable covers, when the design of the covers is symmetrical, such that the first and the third engaging portions are respectively interchangeable with the second and the fourth engaging portions.

### BRIEF DESCRIPTION OF THE DRAWINGS

The present invention can be more fully understood by reading the subsequent detailed description in conjunction with the examples and references made to the accompanying drawings, wherein:

FIG. 1A is an exploded diagram of the conventional mobile phone;

FIG. 1B is a local enlarged view of FIG. 1A;

FIG. 2A is a perspective diagram of the mobile phone with detachable covers in accordance with a first embodiment of the present invention (wherein the cover is in an opened position).

FIG. 2B is a perspective diagram of the mobile phone with detachable covers in accordance with the first embodiment of the present invention (wherein the cover is in a closed position but unlocked).

FIG. 2C is a perspective diagram of the mobile phone with detachable covers in accordance with the first embodiment of the present invention (wherein the cover is in a closed and locked position).

FIG. 2D is a perspective view of the mobile phone with detachable covers in accordance with the first embodiment of the present invention.

FIG. 3A is a sectional view of the mobile phone with detachable covers in accordance with a second embodiment of the present invention (wherein a lock is opened).

FIG. 3B is a sectional view of the mobile phone with detachable covers in accordance with a second embodiment of the present invention (wherein a lock is closed).

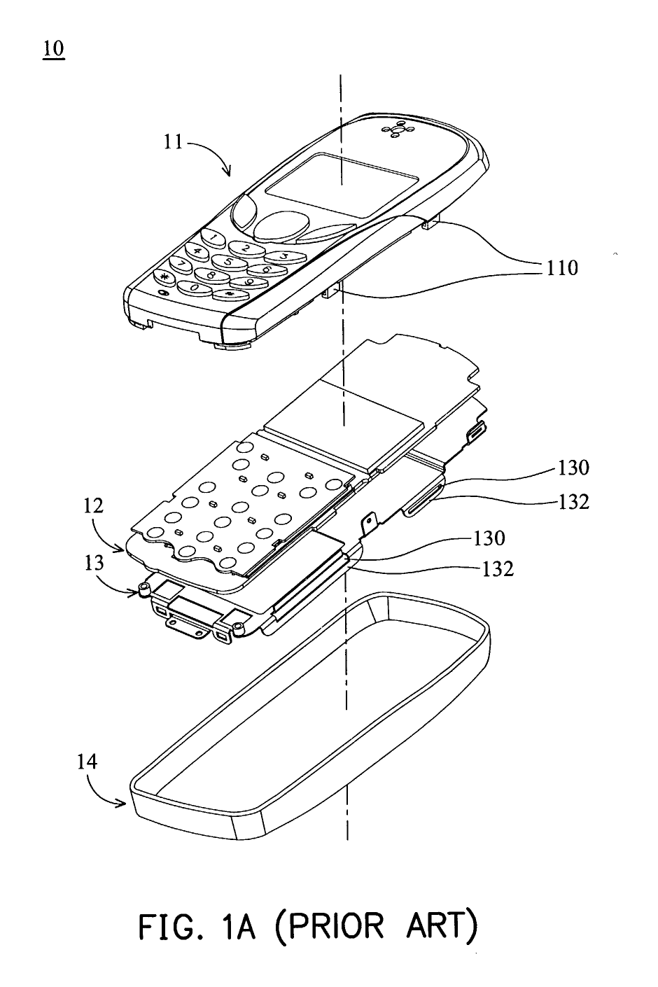

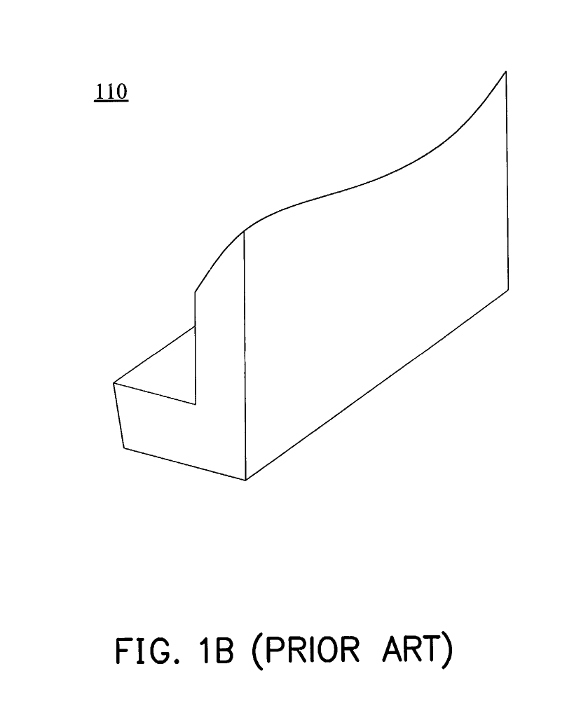

### DETAILED DESCRIPTION OF THE INVENTION

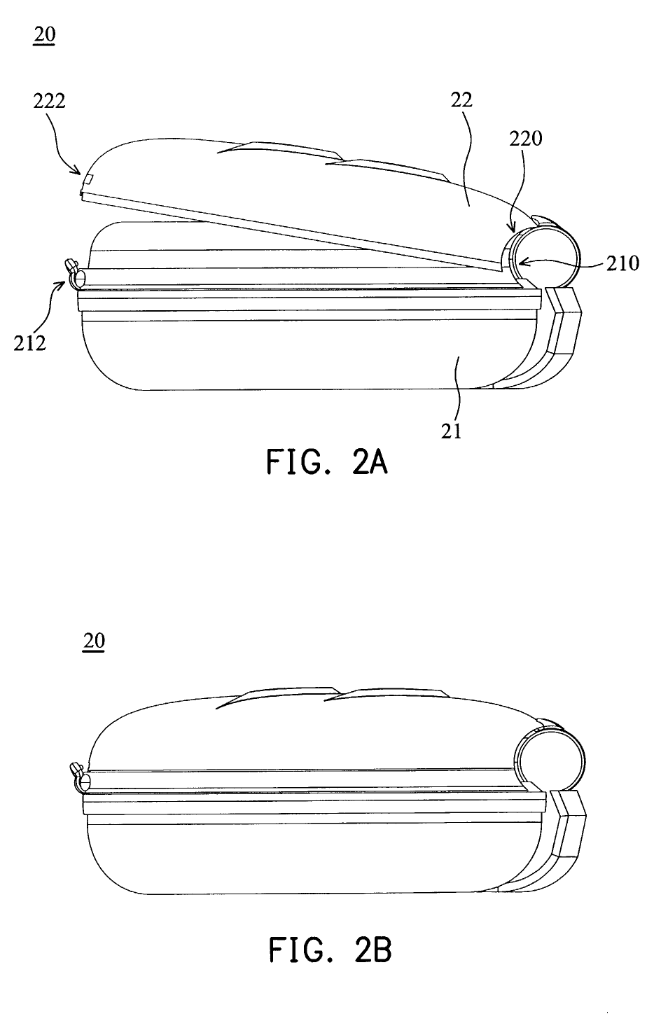

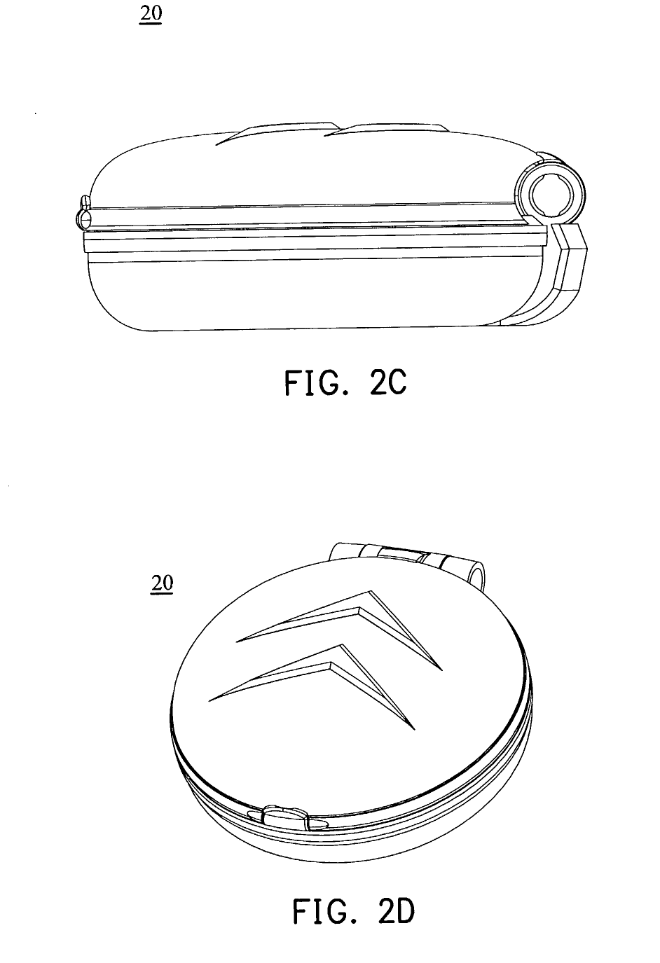

Referring to FIGS. 2A, 2B, 2C, and 2D, a mobile phone with detachable covers in a first embodiment of the present invention includes a body (21) comprising a first engaging portion (210) as a convex portion and a second engaging portion (212) as a lock, and a cover (22) comprising a third engaging portion (220) as a concave portion and a fourth engaging portion (222) defining a hole. The cover (22) is movably disposed on the body (21). FIG. 2A shows the perspective view of the mobile phone in accordance with the present invention where the cover is in an opened position. To fasten the cover (22) to the body (21), the first engaging portion (210) shown on the right side of the figure is fastened to the third engaging portion (220) at a predetermined angle. FIG. 2B is a second perspective diagram of the mobile phone with detachable covers in accordance with the first embodiment where the cover is in a closed position. FIG. 2B shows the cover (22) and the body (21) firmly connected. FIG. 2C is A third perspective diagram showing the second engaging portion (212) as a lock and the fourth engaging portion (222) as a hole fastened together so that the cover (22) and the body (21) are firmly closed thereby. FIG. 2D shows a 3-dimentional view of the mobile phone after assembly.

The mobile phone with detachable covers (20) of the present invention utilizes a movable lock, so the cover (22) can be made of any material, such as metal or plastic. Also, the interior of the cover (22) does not have the design of hooks or grooves; thus, the thickness can be greatly reduced, reducing the weight of the phone. Furthermore, the present invention utilizes the second engaging portion (212) as a lock to fasten the cover (22) to the body (21), so the present invention provides a strong connection between the cover (22) and the body (21) without affecting the appearance of the mobile phone and further effectively protecting the body. Moreover, the present invention includes a second engaging portion designed as a lock to provide conveniently changed covers without trying to engage a hook with a groove. The problem of broken engaging portion due to incorrect external force and the failure of the engaging portion due to fatigue are both avoided. Thus, the reliability of the present invention is greatly increased.

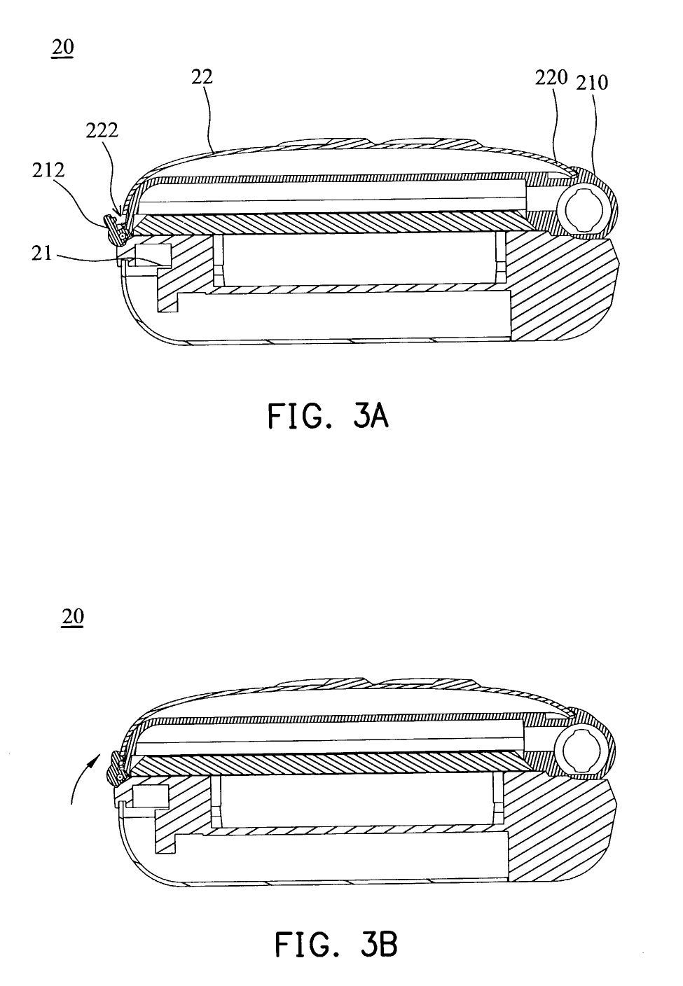

To describe the present invention more thoroughly, a second embodiment is disclosed herein. As shown in FIGS. 3A and 3B, a mobile phone with detachable covers in the second embodiment of the present invention includes a body (21) comprising a first engaging portion (210) as a protrusion and a second engaging portion (212) as a lock, and a cover (22) comprising a third engaging portion (220) as a recessed portion and a fourth engaging portion (222) defining a hole. The cover (22) is movably disposed on the body (21). FIG. 3A is a sectional view of the mobile phone with detachable covers where the cover is in a closed position. To fasten the cover (22) to the body (21), the first engaging portion (210) shown on the right side of the figure is engaged with the third engaging portion (220) at a predetermined angle. FIG. 3B is a sectional view of the mobile phone with detachable covers in accordance with the second embodiment showing the second engaging portion (212) as a lock and the fourth engaging portion (222) defining a hole are fastened together in the direction of the arrow shown in the figure so that the cover (22) and the body (21) are firmly closed.

As well, in the above embodiment, the first engaging portion can be interchanged with the third engaging portion, and the second engaging portion can be interchanged with the fourth engaging portion. Thus, the first engaging portion can be a recessed portion. Then, the second engaging portion defines a hole. The third engaging portion becomes a protrusion and the fourth engaging portion becomes a lock.

Moreover, when the design of the cover is symmetrical, the first engaging portion and the third engaging portion can be interchanged with the second and the fourth engaging portions, respectively. For example, when the first engaging portion is designed as a lock and the second engaging portion is a protrusion, the third engaging portion defines a hole, and the fourth engaging portion becomes a recessed portion. In other words, when the first engaging portion defines a hole and the second engaging portion is a concave portion, the third engaging portion becomes a lock, and the fourth engaging portion becomes a protrusion. In conclusion, the protrusion and the recessed portion are disposed together, and the lock and the hole are paired. The engaging portions are not limited to placement on the body (21) or on the cover (22). Thus, any two of the first, second, third, and fourth engaging portions are able to be paired as a lock-hole combination.

Finally, while the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What Is Claimed Is:

1. A mobile phone with detachable covers, comprising:
a body including a first engaging portion and a second engaging portion; and
a cover, detachably connected to the body, including a third engaging portion and a fourth engaging portion;
wherein the body and the cover are movably connected and the third engaging portion is fastened to the first engaging portion, and the fourth connection is fastened to the second engaging portion.

2. A mobile phone as claimed in claim 1, wherein the first engaging portion is convex and the third engaging portion is concave; the first engaging portion and the third engaging portion are engaged.

3. A mobile phone as claimed in claim 1, wherein the first engaging portion is concave and the third engaging portion is convex; the first engaging portion and the third engaging portion are engaged.

4. A mobile phone as claimed in claim 1, wherein the second engaging portion is a lock and the fourth engaging portion defines a hole to receive the lock.

5. A mobile phone as claimed in claim 1, wherein the second engaging portion defines a hole and the fourth engaging portion is a lock; the hole receives the lock.

6. A mobile phone as claimed in claim 1, wherein the first engaging portion is a recessed portion and the third engaging portion is a protrusion; the first engaging portion and the third engaging portion are engaged.

7. A mobile phone as claimed in claim 1, wherein the first engaging portion is a protrusion and the third engaging portion is a recessed portion; the first engaging portion and the third engaging portion are engaged.
